(19) United States
(12) Patent Application Publication
(10) Pub. No.: US 2019/0351482 A1
(43) Pub. Date: Nov. 21, 2019

(54) Magnetic Flaky Powder and Magnetic Sheet Containing the Same

(71) Applicant: Sanyo Special Steel Co., Ltd., Himeji-shi (JP)

(72) Inventors: Koudai Miura, Himeji-shi (JP); Toshiyuki Sawada, Himeji-shi (JP)

(21) Appl. No.: 16/528,930

(22) Filed: Aug. 1, 2019

Related U.S. Application Data
(63) Continuation of application No. PCT/JP2018/003649, filed on Feb. 2, 2018.

(30) Foreign Application Priority Data
Feb. 3, 2017 (JP) 2017-018363

(51) Int. Cl. B22F 1/00; H01F 1/147; C22C 38/52; C22C 38/04; C22C 38/02; C22C 33/02

(52) U.S. Cl. CPC B22F 1/0055; H01F 1/147; C22C 38/52; C22C 38/04; B22F 2304/10; C22C 33/02; C22C 2202/02; B22F 2301/35; C22C 38/02

(57) ABSTRACT

In order to provide a magnetic flaky powder that has a high real part magnetic permeability (μ′) and a high saturation magnetic flux density in addition to a high FR, and a magnetic sheet containing the same, the present invention provides a magnetic flaky powder, containing a plurality of magnetic flaky particles, wherein: each of the plurality of magnetic flaky particles contains, by mass %, C: 0.1% or more and 3.0% or less, Cr: 1.0% or more and less than 10%, Si: 0% or more and 1.5% or less, Mn: 0% or more and 1.5% or less, Ni: 0% or more and 1.5% or less, Co: 0% or more and 10% or less, and the remainder being Fe and unavoidable impurities; the magnetic flaky powder has a saturation magnetic flux density of more than 1.2 T; and the magnetic flaky powder has an average particle diameter D50 of 10 μm or more and 65 μm or less.

### CROSS-REFERENCE TO RELATED APPLICATIONS

This application is a continuation of International Application No. PCT/JP2018/003649 filed Feb. 2, 2018, and claims priority to Japanese Patent Application No. 2017-018363 filed Feb. 3, 2017, the disclosures of which are hereby incorporated by reference in their entirety.

### BACKGROUND OF THE INVENTION

### Field of the Invention

The present invention relates to a magnetic flaky powder having excellent magnetic properties at high frequencies, and a magnetic sheet containing the same, which are used for various electronic devices and the like.

### Background Art

In recent years, with rapid development of electronic devices and information devices, such as personal computers and smartphones, speeding up of information transmission has progressed. With the speeding up of the information transmission, use of a high frequency band of MHz or more has progressed. In particular, small electronic devices, such as smartphones and the like, have a problem of malfunction due to electromagnetic interference within the devices.

In these electronic devices, a magnetic sheet containing a soft magnetic alloy powder is generally used. As the soft magnetic alloy powder, for example, an Fe—Si—Al sendust alloy as disclosed in JP-A-2014-204051 (Patent Document 1) is used. Patent Document 1 discloses that a magnetic sheet containing a flaky powder of an Fe—Si—Al alloy having an aspect ratio of 15 or more achieves a high magnetic permeability.

In addition, JP-A-2012-009797 (Patent Document 2) discloses a soft magnetic resin composition and an electromagnetic wave absorber, which are able to appropriately adjust an electromagnetic wave absorption frequency in the a frequency band of 1 GHz or more, which are thin, and which are able to acquire an excellent electromagnetic wave absorbability.

Further, JP-A-2010-272608 (Patent Document 3) discloses a flaky magnetic powder used in a range of 500 MHz to 3 GHz containing an Fe—Cr alloy or an Fe—Cr—Si alloy. In Patent Document 3, the Cr content is high, the corrosion resistance is high, the cost is low, and a high real part magnetic permeability (μ′) and a low imaginary part magnetic permeability (μ″) are achieved.

The properties required for the properties of the magnetic sheet are a high real part magnetic permeability (μ′: a real part of magnetic permeability) and a low imaginary part magnetic permeability (μ″: an imaginary part of magnetic permeability). In a high frequency region, due to magnetic resonance phenomenon, real part magnetic permeability (μ′) decreases significantly and imaginary part magnetic permeability (μ″) starts to increase sharply. It is effective to use tan δ (μ″/μ′) as an evaluation of this resonance phenomenon. The frequency at which tan δ is 0.1 is hereinafter referred to as FR (MHz). This FR generally tends to increase in proportion to a saturation magnetic flux density.

### PRIOR ART DOCUMENTS

### Patent Documents

Patent Document 1: JP-A-2014-204051

Patent Document 2: JP-A-2012-009797

Patent Document 3: JP-A-2010-272608

### SUMMARY OF THE INVENTION

### Problems to be Solved by the Invention

A flaky powder of Fe—Si—Al alloy generally has a saturation magnetic flux density of about 1.0 T, and an FR of about 20 MHz. A flaky powder of Fe—Cr or Fe—Cr—Si alloy generally has a saturation magnetic flux density of about 1.2 T, which is higher than that of a sendust alloy, and an FR of 50 MHz or less. Therefore, such an alloy system has a low saturation magnetic flux density and a low FR, and thus has difficulty in absorbing a wide range of electromagnetic waves.

### Solution to the Problems

With respect to such problems, as a result of intensive studies, the present inventors have developed a magnetic flaky powder that has a high real part magnetic permeability (μ′) and a high saturation magnetic flux density in addition to a high FR, and a magnetic sheet containing the same, by containing C instead of containing Cr at a high concentration, and thus have accomplished the prevent invention.

That is, the present invention encompasses the following magnetic flaky powder and magnetic sheet.
[1] A magnetic flaky powder, including a plurality of magnetic flaky particles, wherein:

each of the plurality of magnetic flaky particles includes, by mass %, C: 0.1% or more and 3.0% or less, Cr: 1.0% or more and less than 10%, Si: 0% or more and 1.5% or less, Mn: 0% or more and 1.5% or less, Ni: 0% or more and 1.5% or less, Co: 0% or more and 10% or less, and the remainder being Fe and unavoidable impurities;

the magnetic flaky powder has a saturation magnetic flux density of more than 1.2 T; and

the magnetic flaky powder has an average particle diameter D50 of 10 μm or more and 65 μm or less.
[2] The magnetic flaky powder according to the abovementioned [1], wherein the magnetic flaky powder includes one or more of Si: more than 0% and 1.5% or less, Mn: more than 0% and 1.5% or less, Ni: more than 0% and 1.5% or less, and Co: more than 0% and 10% or less.
[3] A magnetic sheet, including the magnetic flaky powder according to the abovementioned [1].
[4] The magnetic sheet according to the abovementioned [3], wherein the magnetic flaky powder comprises one or more of Si: more than 0% and 1.5% or less, Mn: more than 0% and 1.5% or less, Ni: more than 0% and 1.5% or less, and Co: more than 0% and 10% or less.
[5] The magnetic sheet according to the abovementioned [3], wherein an average value of real part magnetic permeability μ′ in a frequency band of 1 MHz to 5 MHz is 15 to 35.
[6] The magnetic sheet according to the abovementioned [3], wherein a frequency FR at which tan δ defined by the formula: tan δ=imaginary part magnetic permeability μ″/real part magnetic permeability μ′ is 0.1 is 45 to 400.

### Effects of the Invention

The present invention provides a magnetic flaky powder having a high real part magnetic permeability (μ′) and a high saturation magnetic flux density in addition to a high FR, and a magnetic sheet containing the same.

### DETAILED DESCRIPTION OF THE INVENTION

Hereinafter, the present invention will be described.

### <Composition of Magnetic Flaky Powder>

The magnetic flaky powder of the present invention is an aggregate of a plurality of magnetic flaky particles, and each magnetic flaky particle contains, by mass %, C: 0.1% or more and 3.0% or less, Cr: 1.0% or more and less than 10%, Si: 0% or more and 1.5% or less, Mn: 0% or more and 1.5% or less, Ni: 0% or more and 1.5% or less, Co: 0% or more and 10% or less, and the balance being Fe and unavoidable impurities. Hereinafter, the reasons for limiting the composition as described above will be described.

[C: 0.1% or More and 3.0% or Less]

C is an essential element for increasing FR. When an Fe-based alloy powder containing a large amount of C is used as a raw material powder and is crushed and processed, the austenite phase contained in the raw material powder causes a deformation-induced martensitic transformation. It is known that the deformation-induced martensitic transformation increases FR. If the content of C is less than 0.1%, the deformation-induced martensitic transformation will not occur. If the content of C exceeds 3%, the saturation magnetic flux density of the flaky powder will become low. Therefore, the content of C is 0.1% or more and 3.0% or less. The content of C is preferably 0.2% or more and 2.8% or less, more preferably 0.4% or more and 2.6% or less.

[Cr: 1.0% or More and Less than 10%]

Cr is an essential element for lowering a martensitic transformation start temperature Ms (hereinafter sometimes referred to as “Ms point”) and improving corrosion resistance. By adding Cr to lower the Ms point, a residual austenite phase can be generated in the raw material powder. By flattening the raw material powder in this state, a flaky powder having a large average particle diameter and a high flatness (a high aspect ratio) can be obtained. If the content of Cr is less than 1.0%, the retained austenite will not be generated, the hardness of the raw material powder will increase, and the average particle size of the flaky powder will decrease. If the content of Cr is 10% or more, the saturation magnetic flux density of the flaky powder will decrease, and/or, the hardness of the raw material powder will decrease and the average particle size of the flaky powder excessively will increase. Therefore, the content of Cr is 1.0% or more and less than 10%. The content of Cr is preferably 2.0% or more and 9.0% or less, more preferably 3.0% or more and 8.0% or less.

[Si: 0% or More and 1.5% or Less]

Si is an optional component appropriately added for Ms point adjustment and hardness adjustment. If the content of Si exceeds 1.5%, the saturation magnetic flux density of the flaky powder will decrease, and the hardness of the raw material powder will rapidly increase and thus the average particle diameter D50 after flattening will decrease. Therefore, the content of Si is 0% or more and 1.5% or less. The content of Si is preferably more than 0% and 1.5% or less, more preferably 0.1% or more and 0.9% or less, and still more preferably 0.3% or more and 0.7% or less.

[Mn: 0% or More and 1.5% or Less]

Mn is an optional component appropriately added for Ms point adjustment and hardness adjustment. If the content of Mn exceeds 1.5%, the saturation magnetic flux density of the flaky powder will decrease, and the hardness of the raw material powder will rapidly increase and thus the average particle diameter D50 after flattening will decrease. Therefore, the content of Mn is 0% or more and 1.5% or less. The content of Mn is preferably more than 0% and 1.5% or less, more preferably 0.1% or more and 0.9% or less, and still more preferably 0.3% or more and 0.7% or less.

[Ni: 0% or More and 1.5% or Less]

Ni is an optional component appropriately added for Ms point adjustment and hardness adjustment. If the content of Ni exceeds 1.5%, the hardness of the raw material powder will remarkably decrease, and the average particle diameter D50 after flattening will excessively increase. Therefore, the content of Ni is 0% or more and 1.5% or less. The content of Ni is preferably more than 0% and 1.5% or less, more preferably 0.1% or more and 0.9% or less, and still more preferably 0.3% or more and 0.7% or less.

[Co: 0% or More and 10% or Less]

Co is an optional component appropriately added to improve corrosion resistance together with Ms point adjustment and hardness adjustment. Co is one of the few elements that increases the Ms point, and also increases the saturation flux density of the flaky powder. However, since Co is an expensive metal, a large amount of addition rapidly increases a material cost, and thus it is desirable to minimize the content of Co as necessary. Therefore, the content of Co is 0% or more and 10% or less. The content of Co is preferably more than 0% and 10% or less, more preferably 1.0% or more and 8.0% or less, and still more preferably 1.0% or more and 5.0% or less.

<Magnetic Properties of Magnetic Flaky Powder>

The saturation magnetic flux density of the magnetic flaky powder of the present invention is more than 1.2 T. Hereinafter, the reasons why the magnetic characteristics are limited as described above will be described.

The saturation flux density is a magnetic property that increases FR. In order to obtain FR required for electromagnetic wave absorption in a high frequency region, the saturation magnetic flux density is required to exceed 1.2 T. Therefore, the saturation flux density is more than 1.2 T. The saturation magnetic flux density is preferably more than 1.3 T, more preferably more than 1.4 T. The upper limit of the saturation magnetic flux density is not particularly limited, but the saturation magnetic flux density is usually 2.3 T or less. The saturation flux density is measured at an applied magnetic field of 1.2×10³ kA/m using a vibrating sample magnetometer (VSM).

<Average Particle Size of Magnetic Flaky Powder>

The average particle size D50 of the magnetic flaky powder of the present invention is 10 μm or more and 65 μm or less. Hereinafter, the reasons for limiting the average particle diameter as described above will be described.

The average particle diameter D50 is a characteristic that greatly affects formability of a magnetic sheet. If D50 is less than 10 μm, the flaky powder will tend to aggregate, and the flexibility of the magnetic sheet will be reduced. If D50 exceeds 65 μm, projections will be likely to be generated on the sheet surface at the time of sheet formation, and the planarity of the magnetic sheet will be unfavorably reduced. Therefore, D50 is 10 μm or more and 65 μm or less. D50 is preferably 15 μm or more and 60 μm or less, and more preferably 25 μm or more and 55 μm or less. The average particle diameter D50 in the present invention is a particle diameter at a point where the cumulative volume is 50% in the volume-based cumulative frequency distribution curve determined with the total volume of the alloy powder being 100%, and is measure by using a laser diffraction measurement device.

The method for producing the magnetic flaky powder of the present invention can be performed by using the method proposed conventionally. An alloy powder used as a raw material is produced by various atomizing methods, and is flat-processed by dry or wet with a ball mill or attritor apparatus. Thereafter, heat treatment at 200° C. or higher decomposes a residual austenite phase that is present even after the flat processing, increases the saturation magnetic flux density, and improves the FR. The method for producing the magnetic flaky powder of the present invention is specifically as follows.

<Method for Producing Magnetic Flaky Powder>

The magnetic flaky powder of the present invention can be produced by a method including a raw material powder preparation step, a flat processing step and a heat treatment step.

[Raw Material Powder Preparation Step]

A magnetic alloy powder is used as a raw material powder. The magnetic alloy powder used as the raw material powder is an aggregate of a plurality of magnetic alloy particles, and each magnetic alloy particle contains, by mass %, C: 0.1% or more and 3.0% or less, Cr: 1. 0% or more and less than 10%, Si: 0% or more and 1.5% or less, Mn: 0% or more and 1.5% or less, Ni: 0% or more and 1.5% or less, Co: 0% or more and 10% or less, and the balance being Fe and unavoidable impurities. The reasons for limiting the composition and the preferable content of each element are as described above.

The raw material powder can be produced, for example, by various atomizing methods such as a gas atomizing method, a water atomizing method, a disk atomizing method, or a pulverizing method performed after alloying by melting. Since the amount of oxygen contained in the raw material powder is preferably small, the raw material powder is preferably produced by a gas atomization method, and more preferably produced by a gas atomization method using an inert gas. Since the powder produced by the atomization method has a near spherical shape, the flattening of the powder tends to progress more than the powder produced by the pulverization method using attritor processing or the like. Since the powder produced by the pulverization method has a particle diameter smaller than that of the atomized powder, the generation of projections on the surface of the magnetic sheet tends to be suppressed.

The particle size of the raw material powder is not particularly limited, but the particle size of the raw material powder is classified by classification according to the purpose of adjusting the average particle size after flattening, the purpose of removing the powder containing a large amount of oxygen, and other production purposes. It may be adjusted to a desired range.

[Flat Processing Step]

After the raw material powder preparation step, the raw material powder is flattened. Thereby, the flaky powder is obtained. The flattening method is not particularly limited, and the flat processing of the raw material powder can be performed using, for example, an attritor, a ball mill, a vibration mill or the like. Among them, it is preferable to use an attritor that is relatively excellent in flat processing ability. In the case of carrying out dry flattening, it is preferable to use an inert gas. When the flat processing is performed by wet processing, it is preferable to use an organic solvent.

The type of the organic solvent used in the wet flat processing is not particularly limited. The amount of the organic solvent added is preferably 100 parts by mass or more, more preferably 200 parts by mass or more, with respect to 100 parts by mass of the raw material powder. The upper limit of the addition amount of the organic solvent is not particularly limited, and can be appropriately adjusted according to the balance between the required size and shape and the productivity of the flaky powder. The organic solvent may be a water-containing organic solvent, but in order to lower the oxygen content, the water concentration in the organic solvent is preferably 0.002 parts by mass or less with respect to 100 parts by mass of the organic solvent. Although a flattening aid may be used together with the organic solvent, in order to suppress oxidation, the addition amount of the flattening aid is preferably 5 parts by mass or less with respect to 100 parts by mass of the raw material powder.

[Heat Treatment Step]

After the flat processing step, the flaky powder is heat treated. The heat treatment apparatus is not particularly limited as long as the desired heat treatment temperature can be realized. The heat treatment temperature is preferably 200 to 900° C., more preferably 300 to 900° C. By performing the heat treatment at such a temperature, it is possible to decompose a residual austenite phase that is present even after the flat processing, to increase the saturation magnetic flux density, and to improve FR. The heat treatment time is not particularly limited, and can be appropriately adjusted according to the amount of treatment, productivity, and the like. However, when the heat treatment time becomes long, the productivity decreases, and thus the heat treatment time is preferably 8 hours or less.

In the heat treatment step, when the heat treatment atmosphere is air, oxidation of the flaky powder proceeds. Therefore, in order to suppress oxidation of flaky powder, it is preferable to heat-treat flaky powder in vacuum or in inert gas (for example, argon or nitrogen).

From the viewpoint of enhancing the insulation of the magnetic sheet containing the magnetic flaky powder, it may be preferable to use a surface-treated magnetic flaky powder. In the method of producing the magnetic flaky powder, during the heat treatment step, or before or after the heat treatment step, a surface treatment step may be performed as needed. For example, the heat treatment may be performed in an atmosphere containing a small amount of active gas for the surface treatment. Moreover, it is also possible to improve corrosion resistance, dispersibility in rubber, and the like by the surface treatment with, typically, a conventionally proposed cyan coupling agent.

<Magnetic Sheet>

The magnetic sheet of the present invention contains the magnetic flaky powder of the present invention. The magnetic sheet of the present invention has, for example, a structure in which the magnetic flaky powder of the present invention is dispersed in a matrix material such as rubber, elastomer, resin or the like. The matrix material can be selected appropriately, and one type of matrix material may be used, or two or more types of matrix materials may be used.

The amount of the magnetic flaky powder contained in the magnetic sheet can be appropriately adjusted in consideration of the required permeability characteristics and the like. The amount of the magnetic flaky powder contained in the magnetic sheet (volume filling ratio of the magnetic flaky powder in the magnetic sheet) is preferably 20 to 60% by volume, for example, 20 to 40% by volume or 40 to 60% by volume.

The applicable frequency range of the magnetic sheet of the present invention is preferably 50 to 2000 MHz, more preferably 100 to 1000 MHz.

In the magnetic sheet of the present invention, the average value of the real part magnetic permeability μ′ in the frequency band of 1 MHz to 5 MHz is preferably 15 to 35, and more preferably 25 to 35. Here, the complex magnetic permeability p is represented by μ=μ′−jμ″ (wherein μ′ is a real part, μ″ is an imaginary part, j is an imaginary unit ((j)²=−1)). In the present specification, all of the magnetic permeability p, the real part μ′ of the magnetic permeability, and the imaginary part μ″ of the magnetic permeability mean a relative magnetic permeability, which is a ratio to the magnetic permeability of vacuum, and has a dimensionless unit. The average value of the real part magnetic permeability μ′ in the frequency band of 1 MHz to 5 MHz is obtained by cutting out a doughnut-shaped sample having an outer diameter of 7 mm and an inner diameter of 3 mm from a magnetic sheet containing a magnetic flaky powder (the volume filling rate of the flaky powder in the magnetic sheet is 30%), measuring the impedance characteristics in the frequency band of 1 MHz to 5 MHz at room temperature using an impedance measuring instrument, and calculating from the measurement results.

In the magnetic sheet of the present invention, the frequency FR at which tan δ is 0.1, wherein tan δ is defined by the formula: tan δ=imaginary part magnetic permeability μ″/real part magnetic permeability μ′, is preferably 45 to 400, more preferably 50 to 400, and still more preferably 200 to 400. The real part magnetic permeability μ′ and imaginary part magnetic permeability μ″ are obtained by cutting out a doughnut-shaped sample having an outer diameter of 7 mm and an inner diameter of 3 mm from a magnetic sheet containing a magnetic flaky powder (the volume filling rate of the flaky powder in the magnetic sheet is 30%), measuring the impedance characteristics in a predetermined frequency band (e.g., frequency band of 1 MHz to 5 MHz) at room temperature using an impedance measuring instrument, and calculating from the measurement results.

The production of the magnetic sheet containing the magnetic flaky powder can be carried out using the magnetic flaky powder in accordance with a conventionally proposed method. For example, it can be produced by: mixing the magnetic flaky powder with a solution obtained by dissolving chlorinated polyethylene or the like in toluene; applying the obtained mixture to a substrate made of synthetic resin such as polyester resin; drying the obtained product, and compressing the dried product with various presses, rolls, etc.

### EXAMPLES

Hereinafter, the present invention will be specifically described based on examples.

[Production of Flaky Powder]

The alloy powders having the compositions shown in Tables 1 and 2 were produced by gas atomization, classified to 150 μm or less, and used as raw material powders. The gas atomizing method was carried out by using an alumina crucible for melting, pouring molten alloy from a 5 mm diameter nozzle under the crucible, and spraying high pressure argon onto the molten metal.

Subsequently, the raw material powders were flattened by an attritor apparatus. The attritor was loaded with a ball of 4.8 mm in diameter made of SUJ2 into a stirring vessel together with the raw material powder and industrial ethanol, and the blade rotation speed was 250 rpm.

A part of the obtained flaky powders was heat-treated in an atmosphere of Ar or nitrogen in order to remove strain and residual austenite phase introduced during flat processing. The heat treatment temperature was set to 200° C. to 900° C. in consideration of the powder sintering temperature, and the heat treatment time was set to 3 hours.

Evaluation of Flaky Powder]

The obtained flaky powders were evaluated for average particle diameter D50 and saturation magnetic flux density. The average particle diameter D50 is a particle diameter at a point where the cumulative volume is 50% in the volume-based cumulative frequency distribution curve determined with the total volume of the alloy powder being 100%, and is measure by using a laser diffraction measurement device. The saturation magnetic flux density was measured at an applied magnetic field of 1.2×10³ kA/m using a vibrating sample magnetometer (VSM).

[Production and Evaluation of Magnetic Sheet]

Chlorinated polyethylene was dissolved in toluene, and the obtained flaky powder was mixed in this solution. The obtained slurry was applied to a polyester resin, and sheet forming was performed by a doctor blade method. After molding, it was dried for 1 day in a normal temperature and normal humidity environment. Thereafter, pressing was performed at 50° C. and a pressure of 15 to 60 MPa to obtain a magnetic sheet. In all magnetic sheets, the volume filling rate of the flaky powder was equalized to 30% and evaluated.

The resulting magnetic sheet was cut into a donut shape with an outer diameter of 7 mm and an inner diameter of 3 mm, and a real part magnetic permeability μ′ and an imaginary part magnetic permeability μ″ were measured in 1MHz to 1GHz at room temperature using an impedance analyzer (E4991B impedance analyzer manufactured by KEYSIGHT). Then, the average value of the real part magnetic permeability μ′ in 1 to 5 MHz, and the frequency FR at which tan δ defined by the formula: tan δ=the imaginary part magnetic permeability μ″/the real part magnetic permeability μ′ is 0.1 were determined, and the magnetic sheet was evaluated. The evaluation results are shown in Tables 1 and 2.

TABLE 1

| | Ingredient composition (mass %) | | | | | | | |
|---|---|---|---|---|---|---|---|---|
| No | C | Cr | Si | Mn | Ni | Co | Fe | Remarks |
| 1 | 0.10 | 8.0 | 0.0 | 0.0 | 0.0 | 0.0 | Balance | Inventive examples |
| 2 | 0.10 | 8.0 | 0.0 | 0.0 | 0.2 | 1.0 | Balance | |
| 3 | 0.10 | 7.0 | 0.5 | 0.5 | 0.2 | 1.0 | Balance | |
| 4 | 0.10 | 9.0 | 0.3 | 0.3 | 0.4 | 0.0 | Balance | |
| 5 | 0.40 | 2.0 | 0.0 | 0.0 | 0.0 | 0.0 | Balance | |
| 6 | 0.40 | 4.0 | 1.0 | 0.5 | 0.0 | 0.0 | Balance | |
| 7 | 0.40 | 6.0 | 0.0 | 0.0 | 0.0 | 3.0 | Balance | |
| 8 | 0.40 | 9.0 | 0.0 | 0.0 | 0.4 | 5.0 | Balance | |
| 9 | 1.00 | 2.0 | 0.0 | 0.0 | 0.4 | 0.0 | Balance | |
| 10 | 1.00 | 4.0 | 1.0 | 0.5 | 0.4 | 0.0 | Balance | |
| 11 | 1.00 | 6.0 | 0.0 | 0.0 | 0.0 | 0.0 | Balance | |
| 12 | 1.00 | 9.0 | 0.0 | 0.0 | 0.2 | 0.0 | Balance | |
| 13 | 1.50 | 2.0 | 1.0 | 1.0 | 0.5 | 3.0 | Balance | |
| 14 | 1.50 | 4.0 | 0.3 | 0.3 | 0.0 | 3.0 | Balance | |
| 15 | 1.50 | 6.0 | 0.1 | 0.1 | 0.2 | 3.0 | Balance | |
| 16 | 1.50 | 9.0 | 0.1 | 0.5 | 0.0 | 3.0 | Balance | |
| 17 | 2.50 | 8.0 | 0.5 | 0.1 | 0.0 | 5.0 | Balance | |
| 18 | 2.50 | 4.0 | 0.1 | 0.1 | 1.0 | 5.0 | Balance | |
| 19 | 2.50 | 6.0 | 0.3 | 0.4 | 0.0 | 5.0 | Balance | |
| 20 | 2.50 | 9.0 | 0.3 | 0.5 | 0.0 | 5.0 | Balance | |
| 21 | 2.80 | 2.0 | 0.3 | 0.6 | 0.0 | 6.0 | Balance | |
| 22 | 2.80 | 4.0 | 0.3 | 0.7 | 0.0 | 6.0 | Balance | |
| 23 | 2.80 | 6.0 | 0.3 | 0.0 | 0.0 | 6.0 | Balance | |
| 24 | 2.80 | 9.0 | 1.2 | 0.3 | 0.8 | 6.0 | Balance | |

| | Saturation | Average | Real part | | |
|---|---|---|---|---|---|
| | magnetic | particle | magnetic | | |
| | flux density | diameter | permeability | Rrequency | |
| No | Bs (T) | D50 (μm) | (μ′) | FR (MHz) | Remarks |
| 1 | 1.9 | 64 | 31 | 53 | Inventive |
| 2 | 1.9 | 61 | 31 | 53 | examples |
| 3 | 1.9 | 62 | 31 | 48 | |
| 4 | 1.9 | 64 | 30 | 58 | |
| 5 | 1.9 | 57 | 32 | 60 | |
| 6 | 1.9 | 57 | 31 | 70 | |
| 7 | 1.9 | 60 | 30 | 80 | |
| 8 | 1.9 | 64 | 29 | 95 | |
| 9 | 1.7 | 47 | 29 | 135 | |
| 10 | 1.7 | 51 | 28 | 145 | |
| 11 | 1.7 | 56 | 27 | 155 | |
| 12 | 1.7 | 60 | 26 | 170 | |
| 13 | 1.6 | 25 | 27 | 198 | |
| 14 | 1.6 | 28 | 26 | 208 | |
| 15 | 1.6 | 31 | 25 | 218 | |
| 16 | 1.6 | 36 | 23 | 233 | |
| 17 | 1.3 | 18 | 19 | 353 | |
| 18 | 1.4 | 14 | 21 | 333 | |
| 19 | 1.3 | 17 | 20 | 343 | |
| 20 | 1.3 | 13 | 18 | 358 | |
| 21 | 1.3 | 13 | 20 | 360 | |
| 22 | 1.3 | 14 | 19 | 370 | |
| 23 | 1.3 | 10 | 18 | 380 | |
| 24 | 1.3 | 11 | 17 | 395 | |

TABLE 2

| | Ingredient composition (mass %) | | | | | | | |
|---|---|---|---|---|---|---|---|---|
| No | C | Cr | Si | Mn | Ni | Co | Fe | Remarks |
| 25 | 0.05 | 6.0 | 0.0 | 0.0 | 0.0 | 0.0 | Balance | Comparative examples |
| 26 | 0.03 | 3.0 | 0.2 | 0.3 | 0.0 | 0.0 | Balance | |
| 27 | 0.03 | 4.0 | 1.0 | 1.0 | 0.0 | 0.0 | Balance | |
| 28 | 3.20 | 3.0 | 0.3 | 0.3 | 0.0 | 4.0 | Balance | |
| 29 | 3.20 | 3.0 | 0.1 | 0.3 | 0.0 | 2.0 | Balance | |
| 30 | 3 10 | 1.0 | 0.1 | 1.0 | 1.0 | 3.0 | Balance | |
| 31 | 3.30 | 6.0 | 0.1 | 0.1 | 0.5 | 8.0 | Balance | |
| 32 | 2.80 | 0.5 | 0.3 | 0.3 | 0.5 | 0.0 | Balance | |
| 33 | 2.80 | 0.3 | 0.2 | 0.2 | 0.0 | 0.0 | Balance | |
| 34 | 1.30 | 13.0 | 0.4 | 0.1 | 0.0 | 1.0 | Balance | |
| 35 | 1.30 | 13.0 | 0.4 | 0.1 | 0.0 | 1.0 | Balance | |
| 36 | 1.20 | 14.0 | 0.6 | 0.1 | 0.2 | 1.0 | Balance | |
| 37 | 2.30 | 20.0 | 1.0 | 1.0 | 0.0 | 2.0 | Balance | |
| 38 | 2.30 | 24.0 | 0.2 | 0.2 | 0.0 | 3.0 | Balance | |
| 39 | 2.50 | 6.0 | 2.0 | 0.5 | 0.1 | 4.0 | Balance | |
| 40 | 2.50 | 10.0 | 3.0 | 0.0 | 0.0 | 4.0 | Balance | |
| 41 | 2.10 | 3.0 | 1.0 | 2.0 | 0.1 | 3.0 | Balance | |
| 42 | 2.10 | 6.0 | 0.3 | 3.0 | 0.1 | 5.0 | Balance | |
| 43 | 0.40 | 6.0 | 0.4 | 0.5 | 2.0 | 0.0 | Balance | |
| 44 | 0.40 | 7.0 | 0.0 | 0.0 | 3.0 | 0.0 | Balance | |
| 45 | 0.20 | 4.0 | 1.0 | 1.0 | 6 0 | 0.0 | Balance | |
| 46 | 1.20 | 4.0 | 2.0 | 3.0 | 0.1 | 3.0 | Balance | |

| | Saturation | Average | Real part | | |
|---|---|---|---|---|---|
| | magnetic | particle | magnetic | | |
| | flux density | diameter | permeability | Rrequency | |
| No | Bs (T) | D50 (μm) | (μ′) | FR (MHz) | Remarks |
| 25 | 2.0 | 80 | 32 | 36 | Comparative |
| 26 | 2.0 | 152 | 33 | 19 | examples |
| 27 | 2.0 | 143 | 33 | 24 | |
| 28 | 1.2 | 7 | 18 | 415 | |
| 29 | 1.2 | 8 | 18 | 415 | |
| 30 | 1.2 | 9 | 19 | 393 | |
| 31 | 1.1 | 6 | 16 | 443 | |
| 32 | 1.3 | 9 | 21 | 353 | |
| 33 | 1.3 | 9 | 21 | 352 | |
| 34 | 1.6 | 67 | 22 | 228 | |
| 35 | 1.6 | 69 | 22 | 228 | |
| 36 | 1.6 | 77 | 22 | 220 | |
| 37 | 1.0 | 78 | 14 | 388 | |
| 38 | 0.9 | 125 | 12 | 408 | |
| 39 | 1.3 | 8 | 20 | 343 | |
| 40 | 1.3 | 8 | 18 | 363 | |
| 41 | 1.5 | 7 | 23 | 278 | |
| 42 | 1.4 | 5 | 22 | 293 | |
| 43 | 1.9 | 175 | 30 | 80 | |
| 44 | 1.9 | 154 | 30 | 85 | |
| 45 | 1.9 | 231 | 32 | 45 | |
| 46 | 1.7 | 9 | 27 | 170 | |

Note 1)
Underline means not being within the present invention.

No. 1 to No. 24 in Table 1 are inventive examples, whereas No. 25 to No. 46 are comparative examples.

In comparative examples No. 25 to No. 27, the C content is low, and thus the average particle diameter D50 is large. In comparative examples No. 28 to No. 31, the C content is high, and thus the average particle diameter D50 is small and the saturation magnetic flux density is low.

In comparative examples No. 32 to No. 33, the Cr content is low, and thus the average particle diameter D50 is small. In comparative examples No. 34 to No. 36, the Cr content is high, and thus the average particle diameter D50 is large. In comparative examples No. 37 to No. 38, the Cr content is high, and thus the average grain size D50 is large and the saturation magnetic flux density is small.

In comparative example No. 39, the Si content is high, and thus the average particle diameter D50 is small. In comparative example No. 40, the Cr content and the Si content are high, and thus the average particle size is small. In comparative example No. 41 to No. 42, the Mn content is high, and thus the average particle diameter D50 is small. In comparative examples No. 43 to No. 45, the Ni content is high, and thus the average particle diameter D50 is large. In comparative example No. 46, the Si content and the Mn content are high, and thus the average particle diameter D50 is small. Note that in comparative examples No. 25 to No. 46, the average particle diameters do not fall within the desired range, and thus they are regarded as not being able to be used as a magnetic sheet, and the real part magnetic permeability (μ′) and FR are not evaluated.

On the other hand, all of inventive examples No. 1 to No. 24 satisfy the conditions of the present invention, and thus the average particle diameter D50 and the saturation magnetic flux density have the desired characteristics.

As described above, the present invention has the feature of containing C instead of containing Cr at a high concentration, and thus provides a magnetic flaky powder having a high real part magnetic permeability (μ′) and a high saturation magnetic flux density in addition to a high FR, and a magnetic sheet containing the same.

1. A magnetic flaky powder, comprising a plurality of magnetic flaky particles, wherein:
each of the plurality of magnetic flaky particles comprises, by mass %, C: 0.1% or more and 3.0% or less, Cr: 1.0% or more and less than 10%, Si: 0% or more and 1.5% or less, Mn: 0% or more and 1.5% or less, Ni: 0% or more and 1.5% or less, Co: 0% or more and 10% or less, and the remainder being Fe and unavoidable impurities;
the magnetic flaky powder has a saturation magnetic flux density of more than 1.2 T; and
the magnetic flaky powder has an average particle diameter D50 of 10 μm or more and 65 μm or less.

2. The magnetic flaky powder according to claim 1, wherein the magnetic flaky powder comprises one or more of Si: more than 0% and 1.5% or less, Mn: more than 0% and 1.5% or less, Ni: more than 0% and 1.5% or less, and Co: more than 0% and 10% or less.

3. A magnetic sheet, comprising the magnetic flaky powder according to claim 1.

4. The magnetic sheet according to claim 3, wherein the magnetic flaky powder comprises one or more of Si: more than 0% and 1.5% or less, Mn: more than 0% and 1.5% or less, Ni: more than 0% and 1.5% or less, and Co: more than 0% and 10% or less.

5. The magnetic sheet according to claim 3, wherein an average value of real part magnetic permeability μ′ in a frequency band of 1 MHz to 5 MHz is 15 to 35.

6. The magnetic sheet according to claim 3, wherein a frequency FR at which tan δ defined by the formula: tan δ=imaginary part magnetic permeability μ″/real part magnetic permeability μ′ is 0.1 is 45 to 400.
